(19) United States
(12) Patent Application Publication
(10) Pub. No.: US 2024/0159008 A1
(43) Pub. Date: May 16, 2024

(54) COVER FOR A COMPONENT OPENING OF A COMPONENT, IN PARTICULAR AN OFFSHORE STRUCTURE

(71) Applicant: RWE OFFSHORE WIND GMBH, Essen (DE)

(72) Inventors: Marc Schedelgarn, Münsterdorf (DE); Miriam Vogt, Hamburg (DE)

(21) Appl. No.: 18/549,532

(22) PCT Filed: Mar. 10, 2022
(86) PCT No.: PCT/EP2022/056125

§ 371 Date: Sep. 7, 2023

(30) Foreign Application Priority Data
Mar. 11, 2021 (DE) 10 2021 105 973.9

(51) Int. Cl. E02D 5/22; E02B 17/00; E02B 17/02; E02D 27/42; E02D 27/50; E02D 27/52; E02D 31/00

(52) U.S. Cl. CPC E02D 5/226; E02B 17/02; E02D 5/223; E02D 27/50; E02D 27/525; E02D 31/00; E02B 2017/0043; E02B 2017/0091; E02D 27/425

(57) ABSTRACT

The invention relates to an assembly (1) comprising: —a hollow component (2) with a component opening (3), —a cover (4), by means of which the component opening (3) is closed, and —a fan (5) for ventilating the interior (6) of the component (2), wherein the fan (5) is pivotally secured to the cover (4). The component opening of the component (2) can be closed by the cover (4) so that the interior (6) of the component (2) is protected against external influences. The formation of mold in the interior (6) of the component (2) can be prevented by means of the fan (5). Because the fan (5) is pivotally held on the cover (4), the interior (6) of the component (2) is particularly readily accessible.

The invention relates to a method for assembling an offshore construction, in particular an offshore wind power plant. In addition, the invention relates to an arrangement which has a hollow component with a component opening, in particular a pile which is open at the top. The component opening is closed with a covering, in order to protect the component against external influences between assembly steps.

Offshore wind power plants usually have a hollow pile as foundation structure. In order to assemble an offshore wind power plant, the pile is first of all anchored in the seabed. Subsequently, a tower structure is erected on the pile. Several months can pass in practice between these two steps. It is therefore customary for the pile which is open at the top to be closed by way of a covering until the tower structure is erected. The interior space of the pile is thus protected against external influences. The covering is removed immediately before the tower structure is erected.

Simple tarpaulins which are fastened to the pile by way of tensioning straps are known as coverings for the described purpose. Coverings of this type are often difficult to mount, however, in particular in the case of strong wind. In addition, these coverings close off the pile completely. As a result, mold can be formed in the interior space of the pile. In addition, the access to the interior space of the pile is made more difficult by way of the known coverings, for example for assembly work therein. In particular, what is known as the cable pull in is made more difficult by way of a covering of this type.

It can also be necessary in different fields of application for a component opening of a hollow component to be closed. Mold formation and a lack of accessibility are also known problems here.

It is an object of the present invention, proceeding from the described prior art, for a covering for the component opening of a hollow component to be provided, by way of which covering mold formation is prevented and the accessibility is facilitated.

These objects are achieved by way of the arrangement and the method in accordance with the independent claims.

Further advantageous refinements are specified in the dependent claims. The features which are shown in the claims and in the description can be combined with one another in any desired, technologically appropriate way.

According to the invention, an arrangement is proposed which comprises:
a hollow component of the component opening,
a covering, by way of which the component opening is closed,
a fan for ventilating an interior space of the component via a ventilation opening in the covering, the fan being fastened pivotably to the covering.

The arrangement can be an intermediate product, from which a construction can be obtained. In that case, the covering can temporarily close a component opening of the component. The covering can be removed when the component opening of the component is closed in some other way and in the long term, for example by an attachment part being fastened to the component. The covering can therefore serve to close a component opening in the component during the construction process and to thus protect the interior space against external influences. This is advantageous, in particular, when an electric device is installed in the interior space.

The construction can be, in particular, an offshore wind power plant. In this case, the covering can serve to protect a pile, which is anchored in the seabed and is open at the top, as the component against external influences until the tower structure is mounted on the pile. When the tower structure is mounted, the component opening on the upper side of the pile is closed in the long term by way of the tower structure, with the result that the covering is no longer required. The covering can be intended for single use. In this case, the covering is disposed of when the tower structure is mounted. It is also conceivable, however, that the covering is reused completely or partially. As an alternative, however, the covering can also be used in the case of an intermediate product for any desired other construction, in order to temporarily close a component opening during a construction process.

As an alternative, the arrangement can also be a completed construction. In this case, the covering can in the long term or temporarily close a component opening. For example, the arrangement can be a silo for biogas. The silo can be of cylindrical configuration and, at the top, can have a component opening which is closed in the long term by way of the covering. In this case, the covering serves as roof of the silo. It is also conceivable, however, that, in the case of any desired construction, a lateral component opening is in the long term or temporarily closed by way of the covering.

The arrangement comprises a hollow component. A component is to be understood to mean a part of a construction. The hollow component preferably has a round cross section, in particular a circular cross section. The component can be, in particular, of tubular configuration. The component is preferably cylindrical. The component preferably has a circumferential shell wall. In this case, the component is preferably open on its two end sides. In this case, the component opening which is closed by the covering is formed by way of one of the two open end sides. The component opening preferably extends over the entire end side of the component. It is also conceivable that the component opening is arranged laterally on the component, in particular in a shell wall.

An opening in the component is called a component opening. The designation of component opening serves solely for linguistic differentiation from other openings described herein, in particular from the ventilation opening.

The component opening preferably has a cross-sectional area in the range from 1 to 100 m², in particular in the range from 10 to 50 m². The component opening preferably has a circular cross section, in particular with a diameter in the range from 1 to 10 m.

Furthermore, the arrangement has the covering, by way of which the component opening is closed. This is to be understood to mean that the covering conceals the component opening and thus protects the interior space against external influences. Weather effects such as rain and snow come into question as external influences. In addition, bird droppings come into question. In the case of an offshore wind power plant, the penetration of seawater in the case of heavy swells additionally come into question. The covering can also be called a cover.

It is not required that the covering closes the component opening in an air-tight manner. In order to prevent mold formation in the interior space of the component, the covering instead even makes the ventilation of the interior space possible. To this end, the arrangement has a fan which is held on the covering. Via the fan, air is preferably conducted from a surrounding area of the arrangement through the ventilation opening in the covering into the interior space of the component. It is also conceivable that air is conducted via the fan from the interior space of the component through the ventilation opening in the covering into the surrounding area of the arrangement. In the following text, the case will be described by way of example in which air is introduced using the fan into the interior space of the component. This applies correspondingly to the reversed case. The ventilation opening preferably has a diameter in the range from 20 to 200 cm.

In order to equalize the pressure in the interior space of the component, the covering preferably has one or more pressure equalization openings. Through the latter, air can escape from the interior space of the component when the air is conveyed using the fan into the interior space of the component. The pressure equalization openings are preferably arranged in such a way that no water can pass via them from the outside into the interior space of the component. A cross section of the ventilation openings is in total preferably less than 10% of the surface area of the covering.

The air can be introduced using the fan directly into the entire interior space of the component. As an alternative, a ventilation hose can adjoin the ventilation opening on the inner side of the covering. Via the ventilation hose, the air can be conducted within the interior space of the component to a desired location. The ventilation hose preferably has a casing wall made from plastic with a wire spiral which is integrated therein and gives the casing wall its shape.

The fan is held pivotably on the covering. This is possible, for example, by the fan being held on the covering via one or more hinges. The fan can be pivoted between a first position and a second position. In the first position, the fan conceals the ventilation opening in the covering, with the result that the fan can convey air through the ventilation opening. This is the operating position, in which the fan can be used to ventilate the interior space of the component. In the second position, the fan is pivoted away from the ventilation opening. The ventilation opening is therefore released. The ventilation opening can thus be used as access to the interior space of the component. In this regard, the described arrangement makes particularly easy access to the interior space of the component possible. In particular, a separate access opening is not required for this purpose in the covering. Nevertheless, the covering can also have one or more access openings in addition to the ventilation opening. As a result of the pivotability of the fan, the access to the interior space of the component is nevertheless facilitated, however, because no access would be possible at the location of the ventilation opening without the pivotability of the fan. If a ventilation hose is attached to the ventilation opening, this can be removed when the fan is pivoted out of the operating position into the second position. The interior space of the pile can Das be made accessible via the ventilation opening despite the ventilation hose.

In order that the fan is accessible, for example in order for it to be possible for the fan to be pivoted, the arrangement preferably has a stairway. The stairway is preferably arranged outside the covering and preferably extends between the edge of the component opening and the fan. Via the stairway, the ventilation opening can be used as access to the interior space of the component when the fan is pivoted away.

In one preferred embodiment of the arrangement, the component is a foundation structure, anchored in the seabed, for an offshore construction.

In this embodiment, the component serves as a foundation of an offshore construction, in particular of an offshore wind power plant. To this end, the component is anchored at one end in the seabed. At the other end, in the case of a normal water level, the component preferably protrudes out of the water. The latter does not rule out a situation where the water can completely enclose the component, for example in the case of heavy swells.

In addition to the component, the offshore construction preferably comprises further elements and, in particular, a component structure. In the case of an offshore wind power plant, for example, a tower structure is a component structure of this type. The tower structure can be fastened directly to the component, or via an intermediate element, in particular via what is known as a transition piece.

In this embodiment, the covering preferably serves to temporarily close the component opening of the component. The covering can thus serve to protect the interior of the component anchored in the seabed until the tower structure is mounted. In this case, the arrangement is an intermediate product, from which an offshore construction such as an offshore wind power plant can be obtained. Although the covering is part of the arrangement, it is not part of the completed offshore construction.

In a further preferred embodiment of the arrangement, the component is a pile, the component opening being arranged on an end side of the pile.

The pile preferably has a closed shell surface. The pile is preferably open on the two end sides. In this regard, the component opening which is closed by the covering is formed on one of the two end sides. The component opening preferably extends over the entire cross section of the pile. The component opening can also be called a pile opening here. An opening in the pile is called a pile opening. The designation of pile opening serves solely for linguistic differentiation from other openings described herein, in particular from the ventilation opening.

The pile can be configured, in particular, as a foundation structure for an offshore construction, in particular for an offshore wind power plant. In the case of art offshore wind power plant, the pile can also be called a monopile. The pile can be driven into the seabed, for example by way of being rammed in or vibrated in. Since the pile is open at the bottom, material of the seabed can pass into the pile in the process. As a result, the pile can be filled with material to such an extent that the seabed has the same level inside and outside the pile. The interior space to be ventilated of the pile extends in this case from the seabed as far as the component opening which is closed by way of the covering.

In a further preferred embodiment of the invention, the fan is arranged in an operating position on an axis of the component opening.

In the operating position, the fan is arranged centrally in relation to the cross section of the component opening in this embodiment. If the component opening is configured on an end side of a component which is configured as a pile, the axis of the component opening preferably coincides with an axis of the pile. In this case, the axis of the pile also runs through the fan when the latter is situated in the operating position.

On account of the pivotability of the fan, the ventilation opening can be released and can be used as access to the interior space of the component. The central arrangement of the fan and, as a consequence, the central arrangement of the ventilation opening benefit the accessibility of the interior space. All points of the interior space can be reached comparatively satisfactorily from a centrally arranged ventilation opening. An axis of the ventilation opening preferably coincides with the axis of the component opening to be closed.

In a further preferred embodiment of the arrangement, the covering has a ring plate, on which the fan is held.

The ring plate is of annular configuration in so far as the ventilation opening is configured in the center of the ring plate. The fan can be held on the ring plate, for example, via one or more hinges. In addition, the ring plate can contribute to the stability of the covering. The ring plate preferably has an external diameter in the range from 50 to 300 cm and an internal diameter in the range from 20 to 200 cm, the internal diameter in every case being smaller than the external diameter.

In a further preferred embodiment of the arrangement, the covering has a rod assembly which is covered with a tarpaulin.

The rod assembly preferably has a multiplicity of rods. For example, rods can be arranged in a spoke-like manner and can extend in each case from the edge of the ventilation opening to the edge of the component opening. The rods are preferably fastened by way of a plug-in connection to the edge of the component opening and/or to the edge of the ventilation opening. The plug-in connections are preferably secured by way of a respective splint. For example, a respective end of the rods can be plugged through a corresponding hole on the edge of the component opening and can be secured by way of a respective splint. As a result of the plug-in connections, the covering can be mounted and dismantled easily. The edge of the ventilation opening can be formed, in particular, by way of the ring plate. In this regard, the ring plate can serve to hold the rod assembly. The rod assembly is covered with a tarpaulin. The interior space of the component is protected by way of the tarpaulin. As a result of the configuration of the covering with tarpaulin and rod assembly, the covering can be particularly easily and correspondingly simply transported, mounted and dismantled. The covering preferably has a mass in the range from 100 to 300 kg.

A method for assembling an offshore wind power plant is proposed as a further aspect of the invention. The method comprises:
a) anchoring a hollow pile in a seabed, with the result that a component opening on an end side of the pile lies above a waterline, the component opening being closed by way of a covering, and a fan for ventilating an interior space of the pile via a ventilation opening in the covering being fastened pivotably to the covering,
b) removing the covering,
c) mounting a construction structure on the pile.

The pile of the offshore construction is a component in the sense of the described arrangement. At the end of step a), there is preferably an arrangement which is configured as described. The described advantages and features of the invention can be used on and transferred to the method in this regard, and vice versa.

The method serves to assemble an offshore construction. The offshore construction is preferably an offshore wind power plant. It is also conceivable, however, that the method is used for assembling different offshore constructions which have one or more piles anchored in the seabed as foundation structure. For example, an offshore construction of this type can be an offshore platform. In the case of a plurality of piles, steps a) and b) are carried out a corresponding number of times.

In step a), a pile is anchored in the seabed. At the end of step a), the component opening is closed by way of a covering. To this end, the pile can first of all be anchored in the seabed, and the covering can subsequently be attached. In this case, step a) comprises that the component opening is closed by way of a covering. The closing of the opening is therefore part of step a) and in this regard part of the method. As an alternative, the pile can be anchored in the seabed with a premounted covering. In this case, a pile is used for step a), in the case of which pile the component opening is closed by way of a covering. The covering unit can be mounted on the pile, for example, in a port, and the pile which is provided with a covering can then be transported to its intended destination. The closing of the opening is not part of the method here, but rather already takes place before the beginning of the method. Furthermore, a fan is held pivotably on the covering at the end of step a). This can be achieved by virtue of the fact that the fan is fastened to the covering when the covering is already mounted on the pile. In this case, step a) comprises that the fan is fastened to the covering. The fastening of the fan is therefore part of step a) and in this regard is part of the method. This is possible both for the case where the covering is fastened to the pile after the pile is anchored in the seabed, and for the case where a pile is used with a premounted covering without fan. As an alternative, a covering with a premounted fan can be used. In this case, step a) is carried out with a covering, to which the fan is fastened pivotably. The covering which is premounted to this extent can be attached to the pile after the latter is anchored in the seabed. As an alternative, a pile can be used, on which a premounted covering with a fan is already premounted.

After step a), the interior space of the pile is protected by way of the covering. The pile can remain in this state until the construction structure is fastened on it. To this end, the covering is removed in step b), for example using a crane. A waiting time preferably passes between step a) and step b). The waiting time is preferably at least one day, in particular at least one month. The pile can spend the winter with the covering unit, for example.

In step c), the construction structure is mounted on the pile. The construction structure is preferably a tower structure, in particular in the case of an offshore wind power plant. In the case of an offshore wind power plant, the tower structure can comprise a tower, a nacelle with generator, and rotor blades which are attached to it. The tower can be mounted directly on the pile. As an alternative, the tower can be connected to the pile via an intermediate element, in particular what is known as a transition piece.

In one preferred embodiment of the method, the covering is split in step b) and subsequently disposed of.

The splitting of the covering can comprise, for example, that the tarpaulin of the covering is severed at a plurality of locations. For example, the tarpaulin can be cut into segments which in each case extend between two adjacent rods of the rod assembly. Furthermore, the splitting of the covering can comprise that a rod assembly of the covering is dismantled.

The surface area of the covering can be decreased by way of the splitting of the covering, with the result that the covering provides less target area for wind. This facilitates the removal of the covering.

The parts of the covering can be collected in a big bag and can thus be transported away. In the present embodiment, the covering is not reused, but rather is disposed of. This facilitates the splitting of the covering in so far as the covering can be destroyed in the process. In addition, it is expedient to use the covering only once. The covering can thus be damaged during use, for example by wind deforming the rod assembly. Detecting and eliminating damage of this type can be complicated.

In a further preferred embodiment of the method, a winch apparatus is mounted outside the covering on an edge of the component opening of the pile between steps a) and b), and the fan is pivoted away out of an operating position, with the result that the interior space of the pile becomes accessible for the winch apparatus via the ventilation opening in the covering.

The interior space of the pile is particularly satisfactorily accessible on account of the pivotability of the fan. In the present embodiment, this circumstance is utilized by way of a winch apparatus. A winch apparatus is to be understood to mean an apparatus which, in addition to a winch, also has fastening means, via which the winch can be fastened to the pile. The winch apparatus is mounted on the edge of the component opening of the pile, that is to say on that end side of the pile which lies above the waterline. In the case of a normal water level, the winch apparatus is arranged outside the water. The fastening means preferably comprises a frame with three or more legs which are fastened to the edge of the component opening.

Loads can be moved by way of the winch apparatus within the interior space of the pile, in particular upward or downward. With the aid of the winch apparatus, for example, a medium voltage circuit can be mounted within the pile. The winch apparatus is preferably dismantled again before step b).

In a further preferred embodiment of the method, the winch apparatus is used to pull in the cable between steps a) and b).

The electricity generated by an offshore wind power plant can be output via a cable laid on the seabed. This cable is connected during the assembly of the offshore wind power plant. To this end, the cable can be guided through a hole, lying below the waterline, in the shell wall of the pile. The cable can subsequently be pulled upward and connected within the pile. This process is called pulling in the cable. In the present embodiment, the winch apparatus is used for this purpose. In this regard, the above-described advantages can be achieved during pulling in of the cable. In particular, it is not necessary for the covering to be removed for pulling in the cable. Instead, it is sufficient for the fan to be pivoted away. As a result of the central arrangement of the ventilation opening, the cable can be pulled upward and connected centrally in the pile. This is advantageous because the cable can thus be kept away from the shell wall of the pile.

The invention will be described in greater detail in the following text on the basis of the figures. The figures show one particularly preferred exemplary embodiment, to which the invention is not restricted, however. The figures and the proportions are shown in them are merely diagrammatic. In the figures:

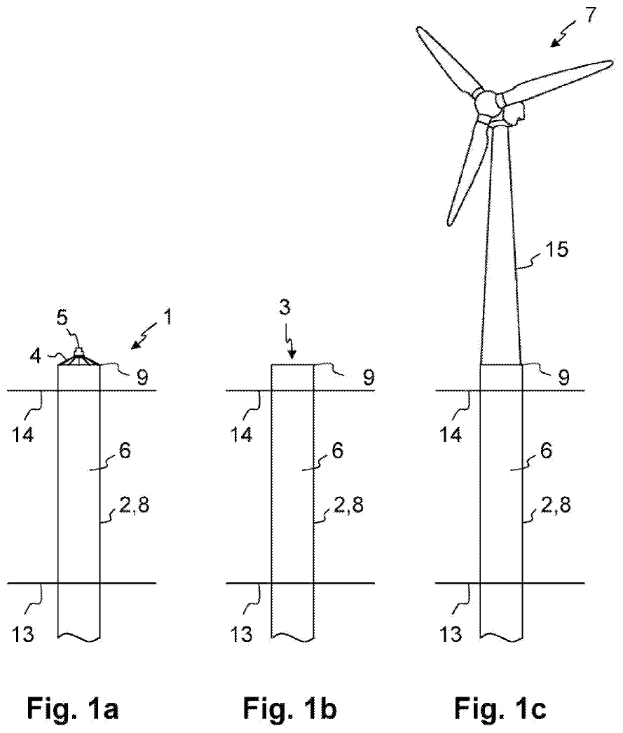

FIGS. 1a to 1c show three stages of a method according to the invention for assembling an offshore wind power plant,

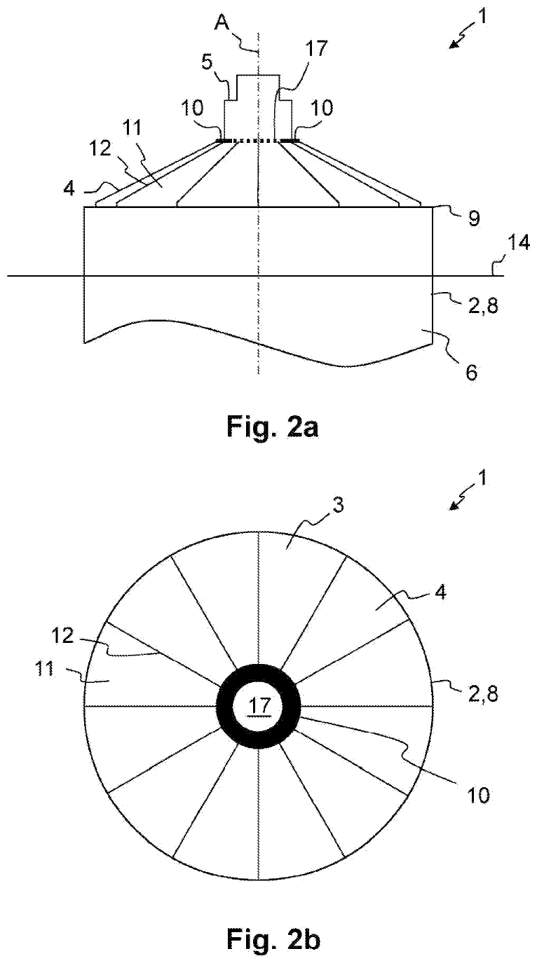

FIG. 2a shows a side view of a part of the arrangement from FIG. 1a,

FIG. 2b shows a plan view of what is shown in FIG. 2a,

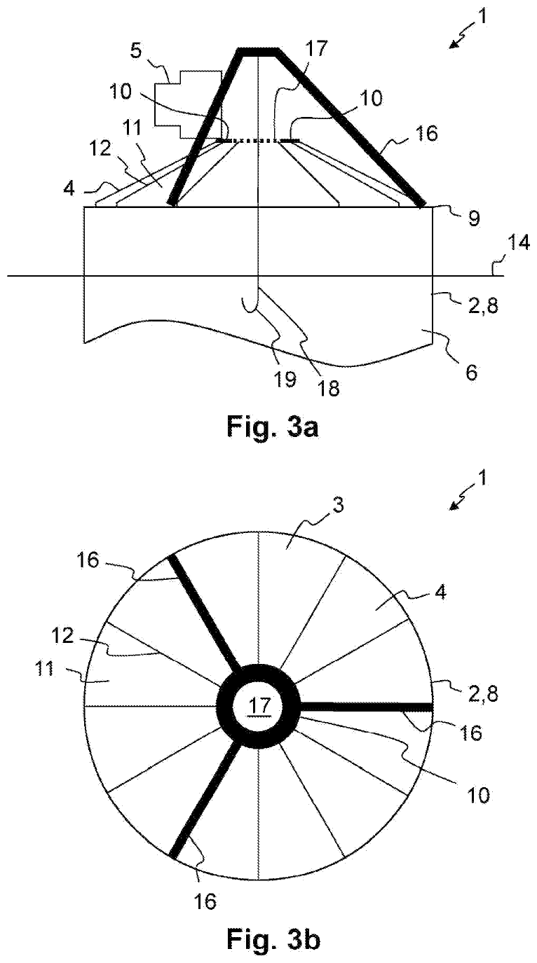

FIG. 3a shows a side view of a part of an arrangement from FIG. 1a in a further state, and

FIG. 3b shows a plan view of what is shown in FIG. 3a.

FIG. 1 illustrates a method for assembling an offshore wind power plant as an offshore construction 7. FIG. 1a illustrates a step a), in which a hollow pile 8 is anchored in a seabed 13, with the result that a component opening 3 (shown in FIG. 1b) on an end side 9 of the pile 8 lies above a waterline 14. The pile 8 is a component 2. The component opening 3 is closed by way of a covering 4, a fan 5 for ventilating an interior space 6 of the pile 8 being fastened pivotably to the covering 4. The interior space 6 of the pile 8 is protected by way of the covering 4. At the end of step a), the arrangement 1 which is shown in FIG. 1a is present. The arrangement 1 comprises the pile 8, the covering 4 and the fan 5.

FIG. 1b illustrates a step b), in which the covering 4 is removed. To this end, the covering 4 can be split and subsequently disposed of.

FIG. 1c illustrates a step c), in which a tower structure is mounted as a construction structure 15 on the pile 8. As a result, the arrangement 1 becomes an offshore construction 7. The previously existing component opening 3 is closed in the long term by way of the tower structure. The pile 8 is a foundation structure, anchored in the seabed 13, for the offshore construction 7.

FIG. 2a shows an enlargement of a part of FIG. 1a. The pile 8 is shown as the component 2 with the end side 9 which is arranged above the waterline 14. On the end side 9, the pile 8 has the component opening 3 (shown in FIGS. 1b and 2b) which is closed by way of the covering 4. The covering 4 has a rod assembly 12 which is covered with a tarpaulin 11. Only one tarpaulin segment with the designation 11 and one rod with the designation 12 are provided by way of example. The fan 5 is arranged on an axis A of the component opening 3. The axis A is at the same time an axis of the component 2. The covering 4 has a ring plate 10. A ventilation opening 17 is configured centrally in the ring plate 10. The interior space 6 of the pile 8 can be ventilated by way of the fan 5 via the ventilation opening 17 in the covering 4. This is possible in that operating position of the fan 5 which is shown in FIG. 2a.

FIG. 2b shows a plan view of what is shown in FIG. 2a. The covering 4 with the tarpaulin 11 and the rod assembly 12 can be seen. Only one tarpaulin segment with the designation 11 and one rod with the designation 12 are also provided here by way of example. The ventilation opening 17 is configured centrally in the ring plate 10. Furthermore, component opening 3 is illustrated. This extends over the entire end side 9 of the pile 8, that is to say over the entire circle provided with the designation 3 in FIG. 2b.

FIG. 3a shows the arrangement 1 from FIG. 2a in a further state. In said figure, the fan 5 is pivoted away out of the operating position which is shown in FIGS. 2a and 2b. In addition, a winch apparatus 16 is mounted outside the covering 4 on an edge of the component opening 3 of the pile 8. For the sake of clarity, the axis A of the component opening is not illustrated here. The interior space 6 of the pile 8 is accessible for the winch apparatus 16 via the ventilation opening 17 in the covering 4. This is indicated in so far as a cable 18 of the winch apparatus 16 is shown which is routed through the ventilation opening 17 into the interior space 6 of the pile 8. The cable 18 is fastened to a winch (not shown) of the winch apparatus 16. A hook 19 is indicated at the other end of the cable 13, via which hook 19 loads can be received. The winch apparatus 16 can be used, in particular, to pull in the cable between steps a) and b).

FIG. 3b shows a plan view of what is shown in FIG. 2a.

The component opening 3 of the component 2 can be closed by way of the covering 4, with the result that the interior space 6 of the component 2 is protected against external influences. Mold formation in the interior space 6 of the component 2 can be prevented by way of the fan 5. The interior space 6 of the component 2 is particularly satisfactorily accessible by virtue of the fact that the fan 5 is held pivotably on the covering 4.

### LIST OF REFERENCE NUMERALS

1 Arrangement
2 Component
3 Component opening
4 Covering
5 Fan
6 Interior space
7 Offshore construction
8 Pile
9 End side
10 Ring plate
11 Tarpaulin
12 Rod assembly
13 Seabed
14 Waterline
15 Construction structure
16 Winch apparatus
17 Ventilation opening
18 Cable
19 Hook
A axis

1. An arrangement (1), comprising:
a hollow component (2) with a component opening (3), the component (2) being a pile (8), and the component opening (3) being arranged on an end side (9) of the pie (8)
a covering (4), by way of which the component opening (3) is closed,
a fan (5) for ventilating an interior space (6) of the component (2) via a ventilation opening (17) in the covering (4), the fan (5) being fastened pivotably to the covering (4).

2. The arrangement (1) as claimed in claim 1, the component (1) being a foundation structure, anchored in a seabed (13), for an offshore construction (7).

3. (canceled)

4. The arrangement (1) as claimed in claim 1, the fan (5) being arranged in an operating position on an axis (A) of the component opening (3).

5. The arrangement (1) as claimed in claim 1, the covering (4) having a ring plate (10), on which the fan (5) is held.

6. The arrangement (1) as claimed in claim 1, the covering (4) having a rod assembly (12) which is covered with a tarpaulin (11).

7. A method for assembling an offshore construction (7), comprising:
a) anchoring a hollow pile (8) in a seabed (13), with the result that a component opening (3) on an end side (9) of the pile (8) lies above a waterline (14), the component opening (3) being closed by way of a covering (4), and a fan (5) for ventilating an interior space (6) of the pile (8) via a ventilation opening (17) in the covering (4) being fastened pivotably to the covering (4),
b) removing the covering (4),
c) mounting a construction structure (15) on the pile (6).

8. The method as claimed in claim 7, the covering (4) being split in step b) and subsequently being disposed of.

9. The method as claimed in claim 7, a winch apparatus (16) being mounted outside the covering (4) on an edge of the component opening (3) of the pile (8) between steps a) and b), and the fan (5) being pivoted away out of an operating position, with the result that the interior space (6) of the pile (8) becomes accessible for the winch apparatus (16) via the ventilation opening (17) in the covering (4).

10. The method as claimed in claim 9, the winch apparatus (16) being used to pull in the cable between steps a) and b).
